(19) United States
(12) Patent Application Publication
(10) Pub. No.: US 2018/0008916 A1
(43) Pub. Date: Jan. 11, 2018

(54) PERFORMANCE INDICATION DEVICE FOR A FILTER

(71) Applicant: Haier US Appliance Solutions, Inc., Wilmington, DE (US)

(72) Inventors: Andrew Reinhard Krause, Louisville, KY (US); Gregory Sergeevich Chernov, Louisville, KY (US)

(21) Appl. No.: 15/203,860

(22) Filed: Jul. 7, 2016

(51) Int. Cl. B01D 35/143; F25D 23/12; B01D 35/30; B01D 29/11; F16K 31/16; F16K 31/54; F25D 11/02

(52) U.S. Cl. CPC B01D 35/143; F16K 31/54; F25D 23/126; F25D 11/02; B01D 29/115; F16K 31/16; B01D 35/30; F25D 2323/121

(57) ABSTRACT

A performance indication device for a filter is provided. The performance indication device includes a water metering device to convert the energy of water flowing through the filter into mechanical rotation of a drive gear. A gear reduction assembly operably couples the drive gear to a valve gear and reduces the rotational speed of the valve gear relative to the drive gear. A flow controlling device is operably coupled to the valve gear and is configured to reduce or terminate the flow of water through the performance indication device and the filter when a target flow capacity is reached. The performance indication device thus provides an accurate indication to the user as to when the filter capacity has been expended without the need for a complex control system or communication link or any modification of the appliance in which the filter is installed.

### FIELD OF THE INVENTION

The present subject matter relates generally to filters, and more particularly to performance indication devices for water filters.

### BACKGROUND OF THE INVENTION

Fluid filter systems, particularly as used for water filtration, typically include a filter constructed with a filter media that removes unwanted particulates and other substances from the fluid. Filtration can be based on size exclusion, adsorption, and other mechanisms. Such filter systems can be provided, e.g., as stand-alone systems or as part of an appliance. For example, refrigeration appliances generally include a filter to remove impurities from the water supply before supplying it to an ice maker or water dispenser. As filtered particles are captured by the filter medium over a period of time, the filter should be cleaned and/or replaced to ensure proper filtration and optimal appliance performance. Accordingly, filter systems frequently provide for an indication to the user that the filter needs to be replaced.

Conventional methods of ensuring timely replacement of filter cartridges may simply rely on periodic illumination of a filter replacement indicator on the user interface panel of the appliance to indicate that the flow capacity has been reached. For example, the appliance controller may be configured to illuminate the filter replacement indicator once a month to remind the user to replace the filter, and the indicator may be dismissed, for example, by pressing a reset button. However, the lifetime of a filter may vary depending on a variety of factors, including water quality and frequency of use. Therefore, a fixed replacement interval is often a poor indicator of filter usage. Moreover, a user may dismiss the indicator without replacing the filter or may forget to replace the filter.

Alternatively, certain conventional filter cartridges may include a flow meter for measuring the amount of water that actually flows through the filter. In such cases, the filter replacement indicator is configured to illuminate after a specific volume of water has been filtered. However, such filter cartridges require some communication link between the flow meter and the appliance controller. Such a communication link may be costly to implement and may require modification of the appliance or appliance controller to ensure compatibility with the filter cartridge. Moreover, because the indicator may be dismissed by the user without replacing the filter, the filter may be used long after its lifetime has expired.

Accordingly, a water filter having improved features for notifying a user when the filter has reached a target flow capacity would be useful. More specifically, a completely integrated performance indication device for a water filter that reduces or terminates the flow of water and provides a visual indication when the filter capacity has been reached would be particularly beneficial.

### BRIEF DESCRIPTION OF THE INVENTION

The present subject matter provides a performance indication device for a filter. The performance indication device includes a water metering device to convert the energy of water flowing through the filter into mechanical rotation of a drive gear. A gear reduction assembly operably couples the drive gear to a valve gear and reduces the rotational speed of the valve gear relative to the drive gear. A flow controlling device is operably coupled to the valve gear and is configured to reduce or terminate the flow of water through the performance indication device and the filter when a target flow capacity is reached. The performance indication device thus provides an accurate indication to the user as to when the filter capacity has been expended without the need for a complex control system or communication link or any modification of the appliance in which the filter is installed. Additional aspects and advantages of the invention will be set forth in part in the following description, or may be apparent from the description, or may be learned through practice of the invention.

In accordance with one embodiment, a performance indication device for a filter is provided. The performance indication device includes an inlet and an outlet in fluid communication with the filter, a drive gear, and a water metering device configured for converting the energy of water flowing through the inlet into the rotational energy of the drive gear. A gear reduction assembly operably couples the drive gear to a valve gear and defines a gear ratio such that the rotational speed of the valve gear is reduced relative to the rotational speed of the drive gear by the gear ratio. A flow controlling device is operably coupled to the valve gear and is configured to reduce or terminate the flow of water through the performance indication device and the filter when a target flow capacity is reached.

In accordance with another embodiment, a fluid filter assembly is provided. The fluid filter assembly includes a filter housing defining a filter chamber, a filter inlet for supplying unfiltered fluid to the filter housing, a filter medium positioned within the filter chamber, the filter medium being operable to remove contaminants from water flowing through the filter medium, and a filter outlet for transferring filtered water from the filter chamber. A performance indication device is positioned adjacent the filter chamber within the filter housing. The performance indication device includes an inlet and an outlet in fluid communication with the filter chamber, a drive gear, and a water metering device configured for converting the energy of water flowing through the inlet into the rotational energy of the drive gear. A gear reduction assembly operably couples the drive gear to a valve gear and defines a gear ratio such that the rotational speed of the valve gear is reduced relative to the rotational speed of the drive gear by the gear ratio. A flow controlling device is operably coupled to the valve gear and is configured to reduce or terminate the flow of water through the inlet when a target flow capacity is reached.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of a refrigerator appliance according to an exemplary embodiment of the present subject matter.

FIG. 2 provides a front view of the exemplary refrigerator appliance of FIG. 1, with refrigerator doors in an open position.

FIG. 3 provides a perspective view of a filter assembly that may be used with the exemplary refrigerator appliance of FIG. 1 according to an exemplary embodiment of the present subject matter.

FIG. 4 provides a cross sectional view of the exemplary filter assembly of FIG. 3, taken along Line 4-4 of FIG. 3.

FIG. 5 provides a perspective view of a performance indication device that may be used with the exemplary filter assembly of FIG. 3 according to an exemplary embodiment of the present subject matter, with the housing removed for clarity.

FIG. 6 provides a cross sectional view of the exemplary performance indication device of FIG. 5, taken along Line 6-6 of FIG. 5.

FIG. 7 provides a close-up perspective view of a drive gear and paddlewheel of the exemplary performance indication device of FIG. 5.

FIG. 8 provides a perspective view of the exemplary performance indication device of FIG. 5, with the housing removed for clarity.

FIG. 9 provides a perspective view of the exemplary performance indication device of FIG. 5, with the housing removed for clarity.

FIG. 10A provides a close-up perspective view of a valve gear of the exemplary performance indication device of FIG. 5 before the filter capacity has been expended.

FIG. 10B provides a bottom view of the exemplary performance indication device of FIG. 5 before the filter capacity has been expended.

FIG. 11A provides a close-up perspective view of the valve gear of the exemplary performance indication device of FIG. 5 after the filter capacity has been expended.

FIG. 11B provides a bottom view of the exemplary performance indication device of FIG. 5 after the filter capacity has been expended.

FIGS. 12A and 12B provide a schematic view of an alternative valve closing mechanism that may be used with the exemplary performance indication device of FIG. 5 in an open position and a closed position, respectively.

FIG. 13 provides a perspective view of a performance indication device that may be used with the exemplary filter assembly of FIG. 3 according to another exemplary embodiment of the present subject matter, with the housing removed for clarity.

FIG. 14 provides a cross sectional view of the exemplary performance indication device of FIG. 13.

FIG. 15 provides a partial perspective view of the exemplary performance indication device of FIG. 13.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

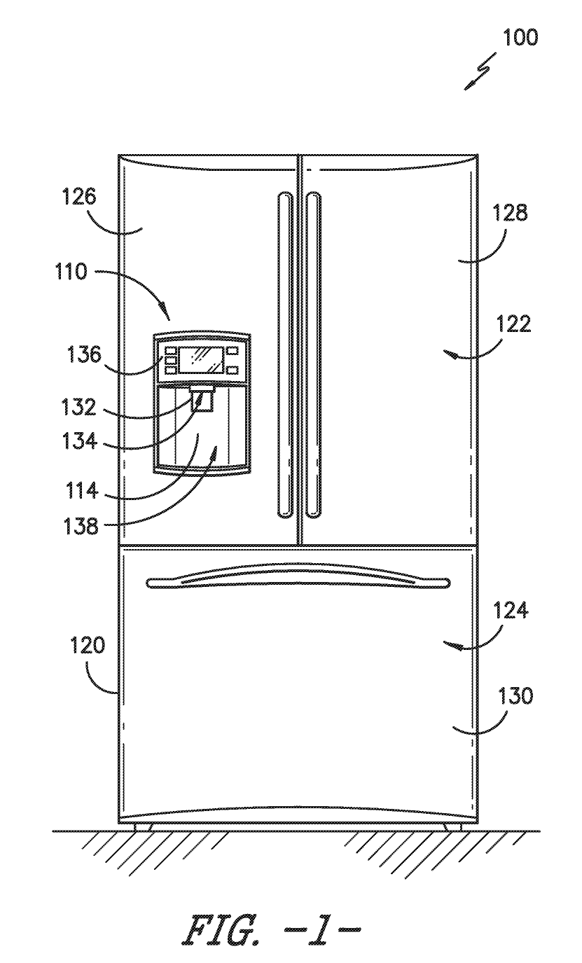

FIG. 1 is a front view of an exemplary embodiment of a refrigerator appliance 100 as may be equipped with a fluid filter assembly according to an exemplary embodiment of the present subject matter. However, as will be understood using the teachings disclosed herein, the fluid filter assembly (including the filter cartridge) of the present subject matter may be used with other refrigerator appliance configurations as well as other types of appliances, and it may also be used in applications other than appliances as well. For example, aspects of the filter assemblies described herein may be applied to under counter water filters, whole house filters, or any other suitable fluid filter assembly. As such, refrigerator appliance 100 is provided by way of example only.

Refrigerator appliance 100 includes a cabinet or housing 120 defining an upper fresh food chamber 122 and a lower freezer chamber 124 arranged below the fresh food chamber 122. As such, refrigerator appliance 100 is generally referred to as a bottom mount refrigerator. In this exemplary embodiment, housing 120 also defines a mechanical compartment (not shown) for receipt of a sealed cooling system. Using the teachings disclosed herein, one of skill in the art will understand that the present invention can be used with other types of refrigerators (e.g., side-by-sides).

Refrigerator doors 126, 128 are rotatably hinged to an edge of housing 120 for accessing fresh food chamber 122. A freezer door 130 is arranged below refrigerator doors 126, 128 for accessing freezer chamber 124. In the exemplary embodiment, freezer door 130 is coupled to a freezer drawer (not shown) that is slidably mounted within freezer chamber 124.

Refrigerator appliance 100 includes a dispensing assembly 110 for dispensing water and/or ice. Dispensing assembly 110 includes a dispenser 114 positioned on an exterior portion of refrigerator appliance 100. Dispenser 114 includes a discharging outlet 134 for accessing ice and water. An activation member 132 is mounted below discharging outlet 134 for operating dispenser 114. In FIG. 1, activation member 132 is shown as a paddle. However, activation member 132 may be any other suitable mechanism for signaling or initiating a flow of ice and/or water into a container within dispenser 114, e.g., a switch or button. A user interface panel 136 is provided for controlling the mode of operation. For example, user interface panel 136 includes a water dispensing button (not labeled) and an ice-dispensing button (not labeled) for selecting a desired mode of operation such as crushed or non-crushed ice.

Discharging outlet 134 and activation member 132 are an external part of dispenser 114, and are mounted in a recessed portion 138 defined in an outside surface of refrigerator door 126. Recessed portion 138 is positioned at a predetermined elevation convenient for a user to access ice or water and enabling the user to access ice without the need to bend-over and without the need to access fresh food chamber 122. In the exemplary embodiment, recessed portion 138 is positioned at a level that approximates the chest level of a user.

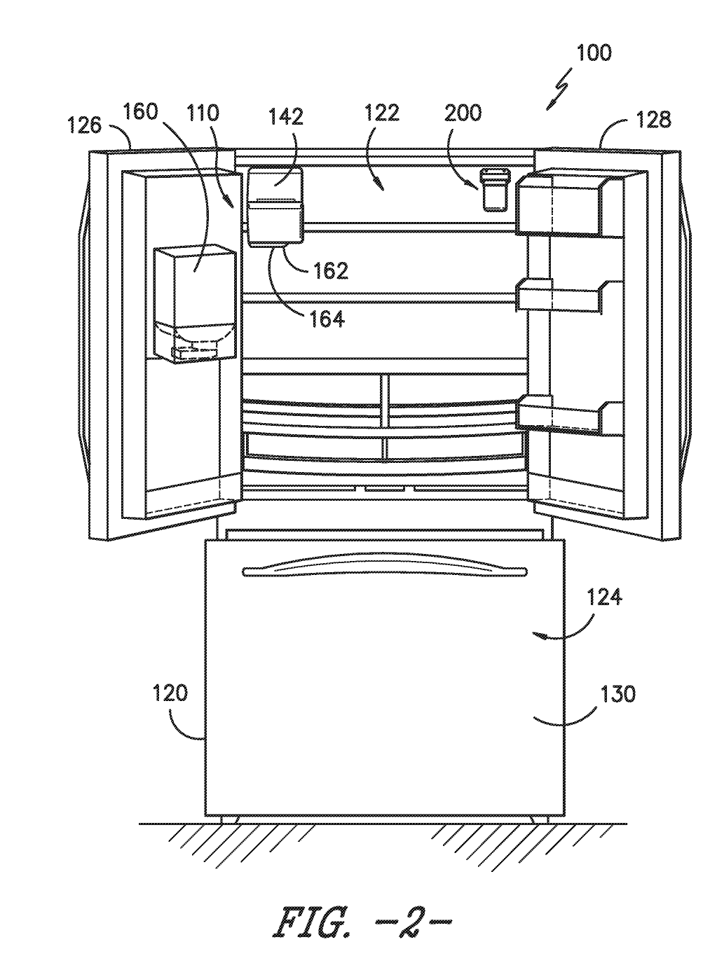

FIG. 2 is a perspective view of refrigerator appliance 100 having refrigerator doors 126, 128 in an open position to reveal the interior of the fresh food chamber 122. As such, certain components of dispensing assembly 110 are illustrated. Dispensing assembly 110 includes an insulated housing 142 mounted within chamber 122. Due to insulation surrounding insulated housing 142, the temperature within insulated housing 142 can be maintained at levels different from the ambient temperature in the surrounding fresh food chamber 122.

In particular, insulated housing 142 is constructed and arranged to operate at a temperature that facilitates producing and storing ice. Insulated housing 142 contains an ice maker (not shown) for creating ice and feeding the same to a receptacle 160 that is mounted on refrigerator door 126. As illustrated in FIG. 2, receptacle 160 is placed at a vertical position on refrigerator door 126 that will allow for the receipt of ice from a discharge opening 162 located along a bottom edge 164 of insulated housing 142 when refrigerator door 126 is in a closed position (shown in FIG. 1). As refrigerator door 126 is closed or opened, receptacle 160 is moved in and out of position under insulated housing 142.

Operation of the refrigerator appliance 100 is regulated by a controller (not shown) that is operatively coupled to user interface panel 136 and/or activation member 132 (shown in FIG. 1). User interface panel 136 provides selections for user manipulation of the operation of refrigerator appliance 100 such as e.g., selections between whole or crushed ice, chilled water, and/or other options as well. In response to user manipulation of the user interface panel 136, the controller operates various components of the refrigerator appliance 100. The controller may include a memory and one or more microprocessors, CPUs or the like, such as general or special purpose microprocessors operable to execute programming instructions or micro-control code associated with operation of refrigerator appliance 100. The memory may represent random access memory such as DRAM, or read only memory such as ROM or FLASH. In one embodiment, the processor executes programming instructions stored in memory. The memory may be a separate component from the processor or may be included onboard within the processor.

The controller may be positioned in a variety of locations throughout refrigerator appliance 100. For example, the controller may be located within beneath the user interface panel 136 on refrigerator door 126. In such an embodiment, input/output (“I/O”) signals may be routed between the controller and various operational components of refrigerator appliance 100. In one exemplary embodiment, the user interface panel 136 may represent a general purpose I/O (“GPIO”) device or functional block. In another exemplary embodiment, the user interface 136 may include input components, such as one or more of a variety of electrical, mechanical or electro-mechanical input devices including rotary dials, push buttons, and touch pads. The user interface panel 136 may be in communication with the controller via one or more signal lines or shared communication busses.

Refrigerator appliance 100 also includes a filter system or fluid filter assembly 200 that filters water coming into refrigerator appliance 100 from a water supply (not shown), such as a municipal water source or a well. Fluid filter assembly 200 can remove contaminants, such as chlorine, chloroform, lead, arsenic, pharmaceuticals, microbes, and/or other undesirable substances, from water supplied to refrigerator appliance 100. In particular, fluid filter assembly 200 can supply filtered water to the ice maker within insulated housing 142 and/or discharging outlet 134. As will be understood by those skilled in the art and as used herein, the term “water” includes purified water and solutions or mixtures containing water and, e.g., elements (such as calcium, chlorine, and fluorine), salts, bacteria, nitrates, organics, and other chemical compounds or substances.

For this exemplary embodiment, filter assembly 200 is shown positioned within fresh food chamber 122. However, filter assembly 200 may also be located e.g., on the exterior of refrigerator 100, on a surface adjacent to refrigerator 100, connected into a water supply line (not shown) providing fluid to refrigerator 100, and other locations as well.

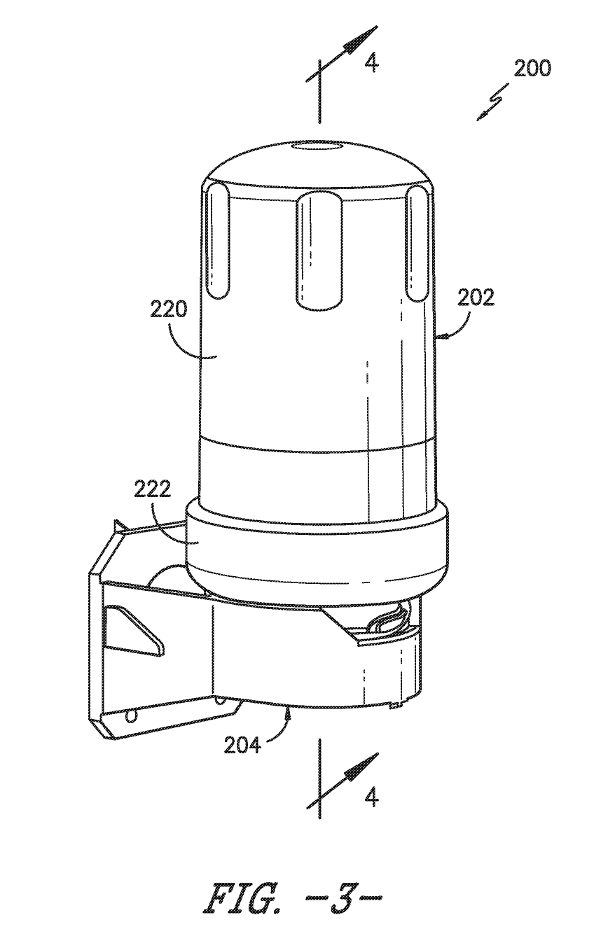

Referring now to FIGS. 3 and 4, this exemplary embodiment of fluid filter assembly 200 includes a filter cartridge 202 mounted to a filter manifold 204. According to the illustrated embodiment, filter manifold 204 is fastened to cabinet 120 within fresh food compartment 122 using, e.g., suitable mechanical fasteners. Filter cartridge 202 may be mounted in filter manifold 204 in any suitable manner. For example, filter cartridge 202 and filter manifold 204 may define mating threads (not shown) such that filter cartridge 202 is secured to filter manifold 204 by inserting and rotating filter cartridge 202. Alternatively, any suitable mechanical fasteners, snap-fit mechanisms, press-fit mechanisms, or other suitable mechanisms may be used to establish a removable connection between filter cartridge 202 and filter manifold 204.

A manifold inlet and manifold outlet (not shown) are provided for a flow of unfiltered fluid into filter assembly 200 and a flow of filtered fluid out of filter assembly 200, respectively. In this regard, manifold inlet and manifold outlet are adapted for coupling filter manifold 202 to a fluid supply system, such as the piping system within a user's dwelling that may be connected with a well or municipal water supply. By way of example, manifold inlet and manifold outlet may be equipped with slip fittings, threads, fasteners, and/or other mechanisms for attachment.

Filter manifold 204 may further include a boss 206 that is configured for engaging filter cartridge 202 and placing manifold inlet in fluid communication with a filter inlet 210 and manifold outlet in fluid communication with a filter outlet 212. In this exemplary embodiment, boss 206 projects from filter manifold 202 along an axial direction A (FIG. 4). Boss 206 defines a fluid return port 216 that is in fluid communication with manifold outlet whereby filtered fluid may be delivered from a filter cartridge 202. Boss 206 also defines a plurality of grooves 218 for the receipt of e.g., O-ring seals (not shown) to ensure a fluid seal when boss 206 is received into filter cartridge 202 as will be further described. In other exemplary embodiments of the invention, the boss 206 may be located on filter cartridge 202 and a receiving port may be provided in filter manifold 204 for receipt of boss 206. In still other embodiments of the invention, filter assembly 200 may not include a boss as some other mechanism may be provided for connecting the flow of filtered fluid from cartridge 202 with filter manifold 204.

As shown in FIG. 4, filter cartridge 202 includes a filter housing 220 and a filter end cap 222 which together define a filter chamber 224 into which a filter element 226 is received. Filter element 226 may be constructed from a variety of different types of filter media including textiles, resins, webs, and other components as well. Filtration with filter element 226 may be based upon e.g., size exclusion, adsorption, and/or other mechanisms. While a variety of different constructions may be used, filter element 226 may, for example, have a hollow cylindrical shape which defines an interior passage 228. In this manner, filter element 226 may be configured so that fluid flows radially inward towards interior passage 228 as particulates or other matter are removed by the filter media.

Filter inlet 210 may generally include multiple apertures (not shown) defined in filter end cap 222 that are in fluid communication with an annular fluid delivery chamber 230 when filter cartridge 202 is properly installed on boss 206. Accordingly, unfiltered fluid from fluid delivery chamber 230 may be delivered into filter chamber 224 for filtration by filter element 226. Unfiltered water flows through filter inlet 210, fills filter chamber 224, and passes generally along the radial direction through cylindrical filter element 226 into interior passage 228. Filtered water then flows through a performance indication device 240 before exiting filter outlet 212, as described in detail below.

According to the illustrated exemplary embodiment, performance indication device 240 is disposed within filter chamber 224 and is configured for measuring the flow of water through filter cartridge 202. Furthermore, performance indication device 240 is configured for reducing or terminating the flow of water when the filter capacity has been reached and providing a visual indication notifying a user that filter cartridge 202 should be replaced. More specifically, as best shown in FIG. 4, performance indication device 240 is placed in fluid communication with interior passage 228 of filter element 226. In this manner, filtered water may flow from interior passage 228 through an inlet 242 of performance indication device 240. The filtered water passes through the performance indication device 240 as will be described in detail below. Filter water then passes through an outlet 244 of performance indication device 240, exits filter cartridge 202, and returns to filter manifold 204 via fluid return port 216.

According to the illustrated embodiment, filter end cap 222 and performance indication device 240 define a filter outlet channel 248 that is configured to receive boss 206. In this regard, filter outlet channel 248 receives boss 206 of filter manifold 202 and provides a surface for sealing with e.g., O-rings in grooves 218 (FIG. 4). Once filter cartridge 202 is installed in filter manifold 204, outlet 244 is in fluid communication with fluid return port 216 defined by boss 206.

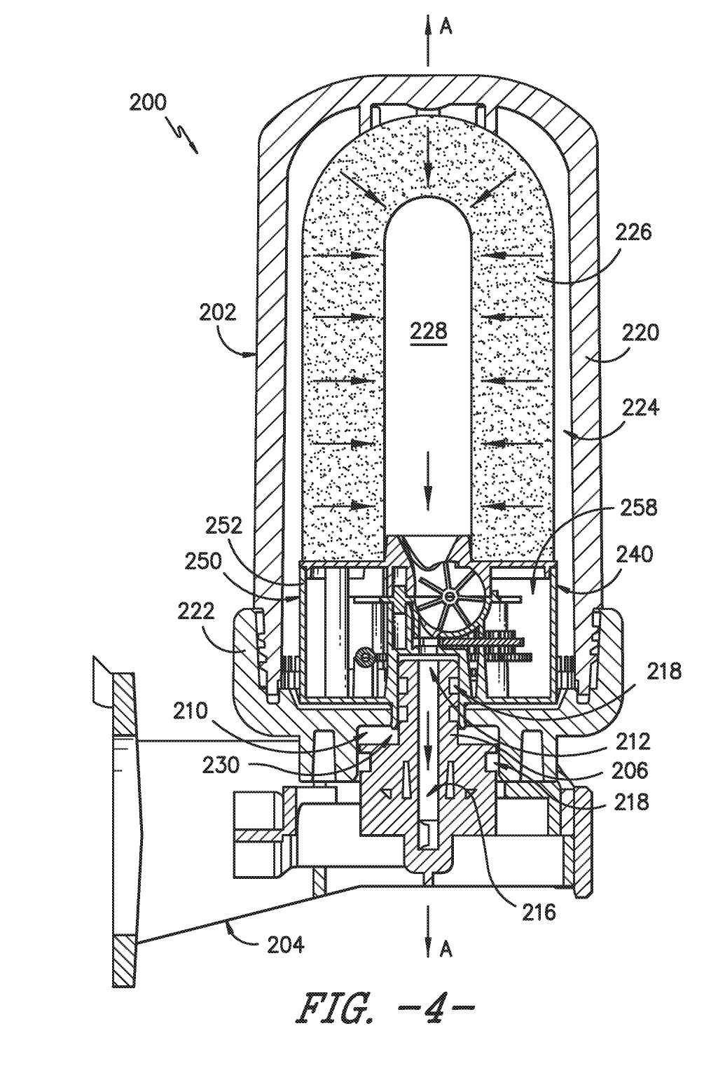

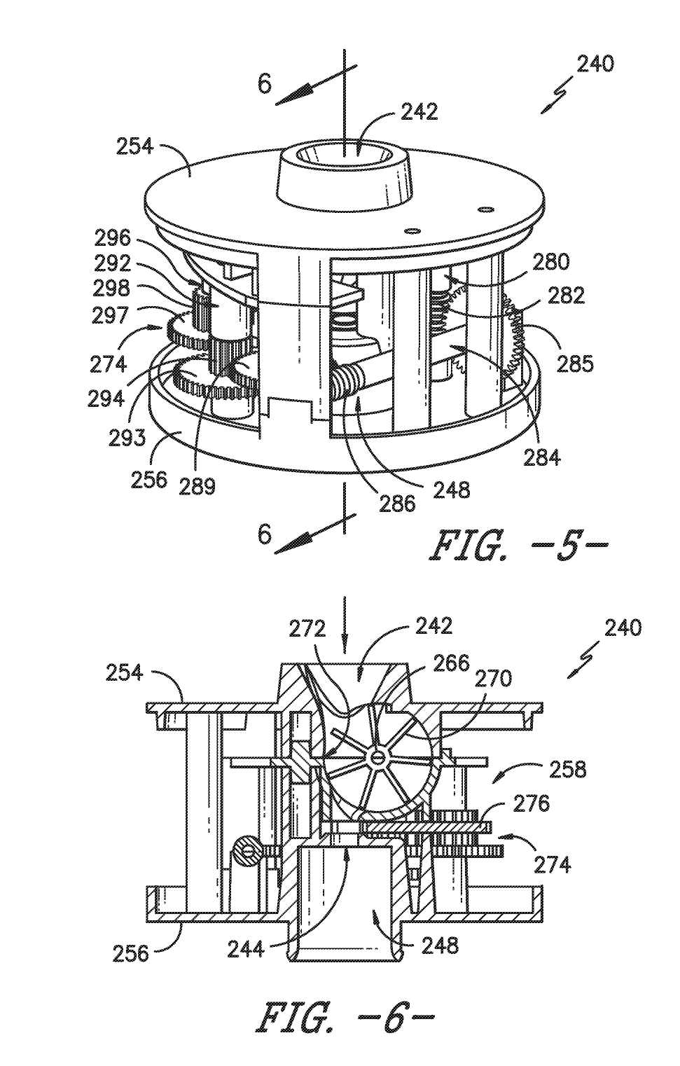

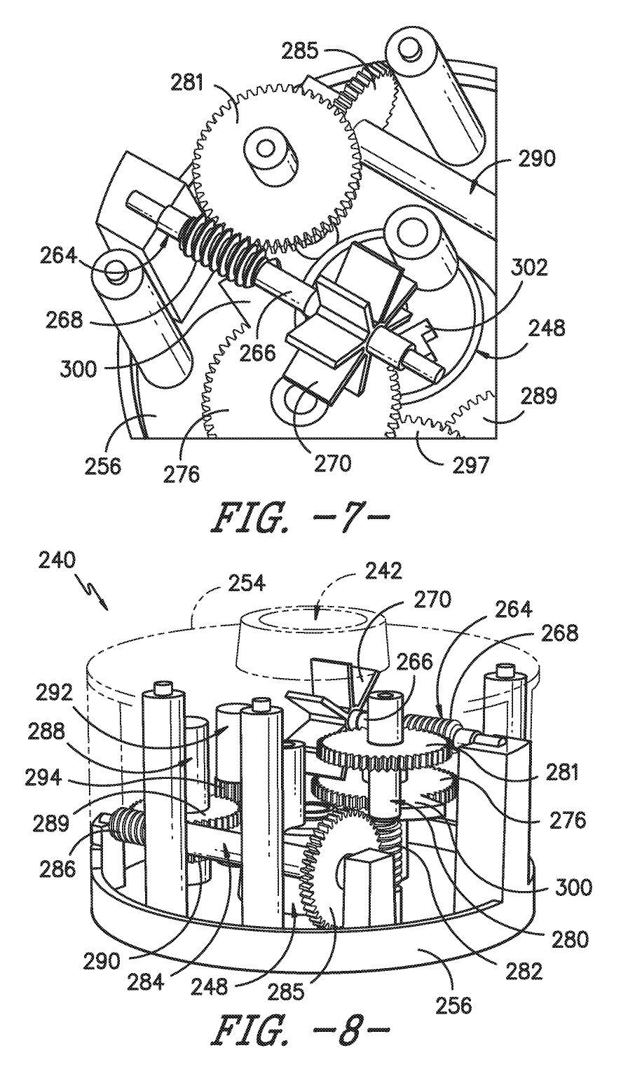

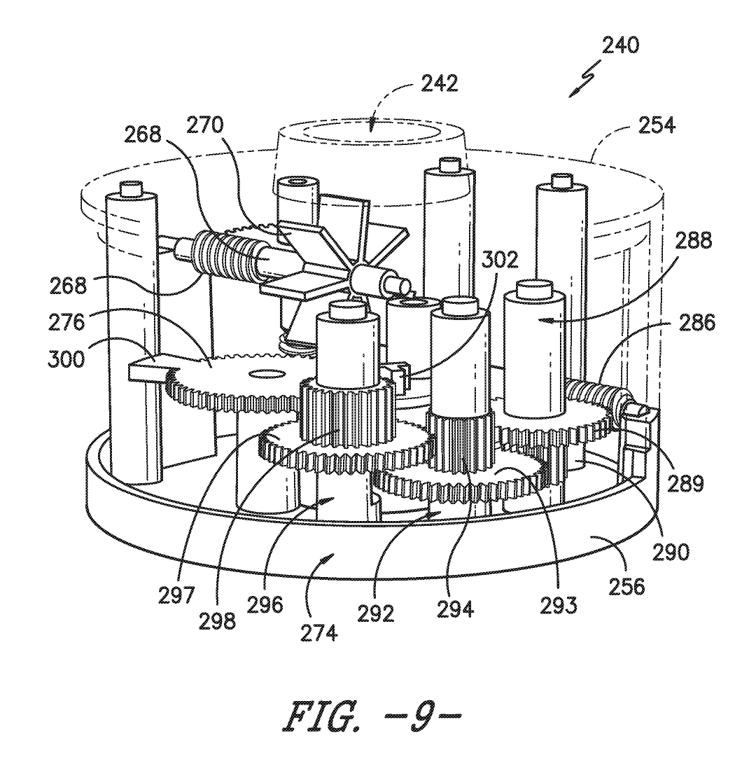

Referring now to FIGS. 5 through 11, the structure and operation of performance indication device 240 will be described in detail. Performance indication device 240 includes a housing 250 including a sidewall 252 (FIG. 4), an inlet cap 254, and an outlet cap 256. Housing 250 defines a hermetically sealed chamber 258 which contains the working components of performance indication device 240. As explained above, inlet 242 is defined in inlet cap 254 and is placed in direct fluid communication with interior passage 228. In this manner, filtered water flows into chamber 258 through inlet 242. Similarly, outlet 244 and filter outlet channel 248 are defined by outlet cap 256, which is placed in direct fluid communication with fluid return port 216 of boss 206.

Performance indication device 240 further includes a drive gear 264, which interacts with water flowing through inlet 242. In general, drive gear 264 includes a drive gear shaft 266 having a water metering device positioned on one end and a worm gear 268 positioned on the other. As explained below, a water metering device is generally configured for converting the energy of water flowing through inlet 242 into the rotational energy of drive gear 264. Drive gear shaft 266 (as well as other gear shafts discussed below) may be rotatably supported within performance indication device 240 using any suitable platforms and/or bushings, as is known in the art.

According to the illustrated embodiment, water metering device is a paddlewheel 270 positioned within a volute 272. Inlet 242 is configured to supply water into one half of volute 272 such that the flowing water engages the fins of paddlewheel 270 and rotates drive gear shaft 266. Notably, the speed of rotation of paddlewheel 270 is proportional to the volumetric flow rate of water through inlet 242 (and thus filter element 226). In this manner, paddlewheel 270 provides a means for measuring the volume of water that flows through filter cartridge 202.

As paddlewheel 270 rotates, drive gear shaft 266 and drive gear 264 rotate and act as an input to a gear reduction assembly 274. Gear reduction assembly 274 operably couples drive gear 264 to a valve gear 276. More specifically, according to the illustrated exemplary embodiment, gear reduction assembly 274 includes multiple gear assemblies that engage each other and define a gear ratio such that the rotational speed of valve gear 276 is reduced relative to the rotational speed of drive gear 264 by the gear ratio. In order to provide sufficient timing that corresponds to the lifetime of filter cartridge 202, a large gear ratio, and thus speed reduction, is required.

According to the illustrated embodiment, gear reduction assembly 274 includes five gear assemblies between drive gear 264 and valve gear 276. A first gear assembly 280 includes a helical gear 281 and a worm gear 282 disposed on opposite ends of a shaft. Helical gear 281 engages worm gear 268 of drive gear shaft 266 with a speed reduction of 50:1. A second gear assembly 284 also includes a helical gear 285 and a worm gear 286 disposed on opposite ends of a shaft. Helical gear 285 of second gear assembly 284 engages worm gear 282 of first gear assembly 280 with a speed reduction of 45:1. A third gear assembly 288 includes a helical gear 289 and a spur gear 290 having different diameters and being positioned adjacent to each other on a vertically oriented shaft. Helical gear 289 of third gear assembly 288 engages worm gear 286 of second gear assembly 284 with a speed reduction of 45:1. A fourth gear assembly 292 includes a first spur gear 293 positioned adjacent a second spur gear 294 on a vertically oriented shaft, and first spur gear 293 has a larger diameter than second spur gear 294. First spur gear 293 of fourth gear assembly 292 engages spur gear 290 of third gear assembly 288 with a speed reduction of 2.78:1. A fifth gear assembly 296 includes a first spur gear 297 positioned adjacent a second spur gear 298 on a vertically oriented shaft, and first spur gear 297 has a larger diameter than second spur gear 298. First spur gear 297 of fifth gear assembly 296 engages the second spur gear 294 of fourth gear assembly 292 with a speed reduction of 2.78:1. Finally, valve gear 276 is configured to engage second spur gear 298 of fifth gear assembly 296 with a speed reduction of 2.31:1. As a result, the total speed reduction between drive gear 264 and valve gear 276 is 1,802,885:1.

One skilled in the art will appreciate that gear reduction assembly 274 is only one exemplary configuration that may achieve a desirable gear ratio. Alternative embodiments may employ other gear arrangements which include a different number, type, or configuration of gears to achieve any particular desired gear ratio. For example, gear reduction assembly 274 may use spur gears, helical gears, worm gears, planetary gears, or any other suitable type of gear in any combination to achieve suitable speed reduction.

Performance indication device 240 further includes a flow controlling device that is operably coupled to valve gear 276. The flow controlling device is generally configured to reduce or terminate the flow of water through performance indication device 240 and filter cartridge 202 when a target flow capacity is reached. Filter capacity is generally defined as the cumulative volume of filtered water passing through filter cartridge 202 during the life of filter element 226. The target flow capacity is typically an amount that is predetermined by the filter manufacturer, but could be adjustable by a user depending on the specific filter application, e.g., based on supply water quality.

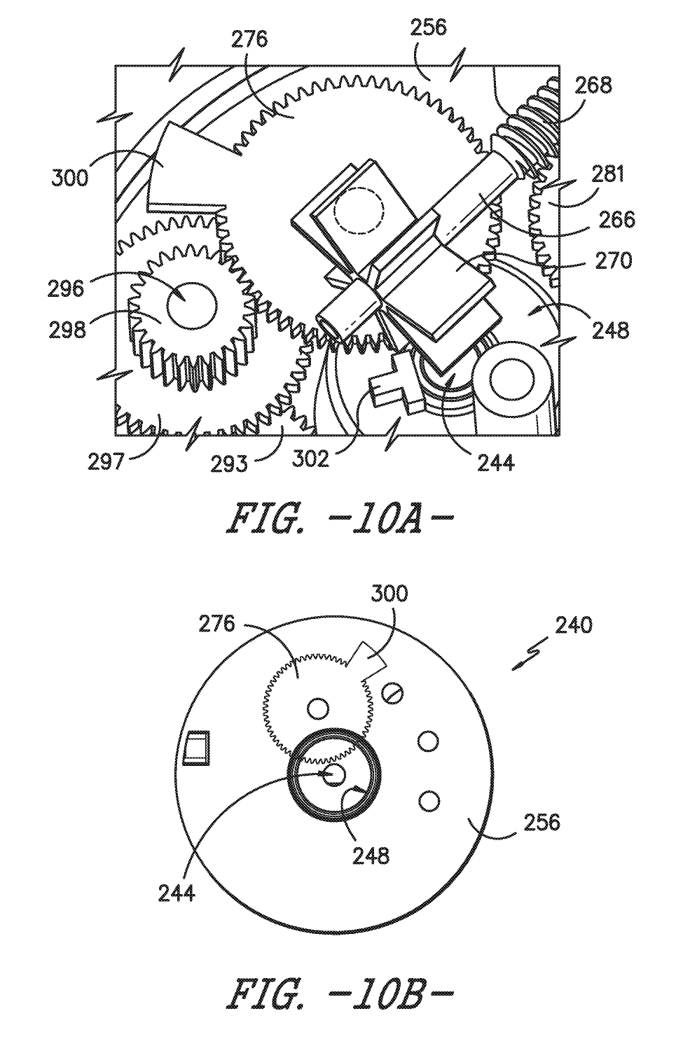

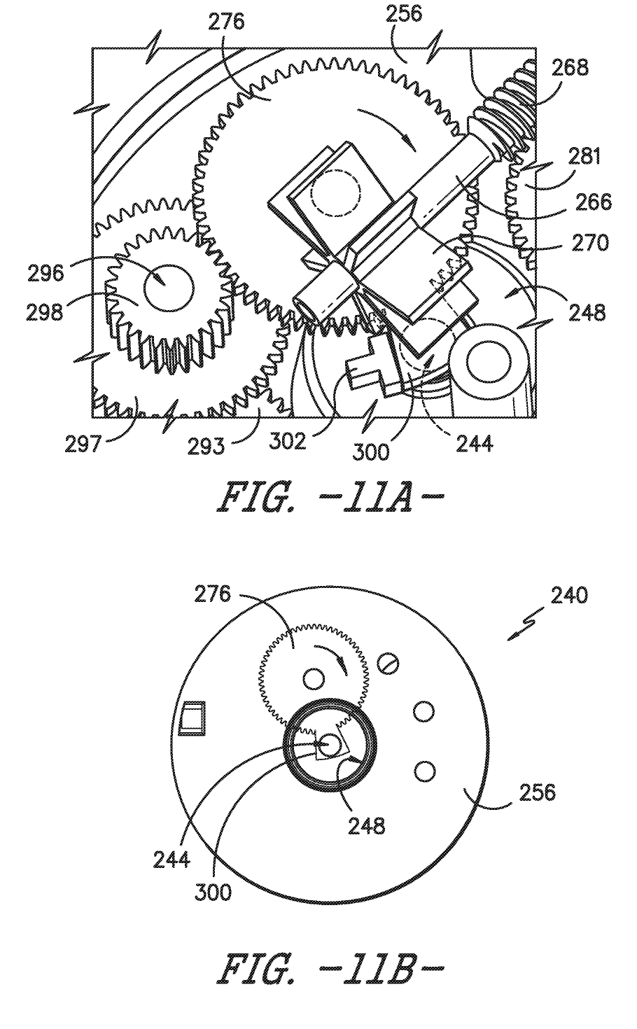

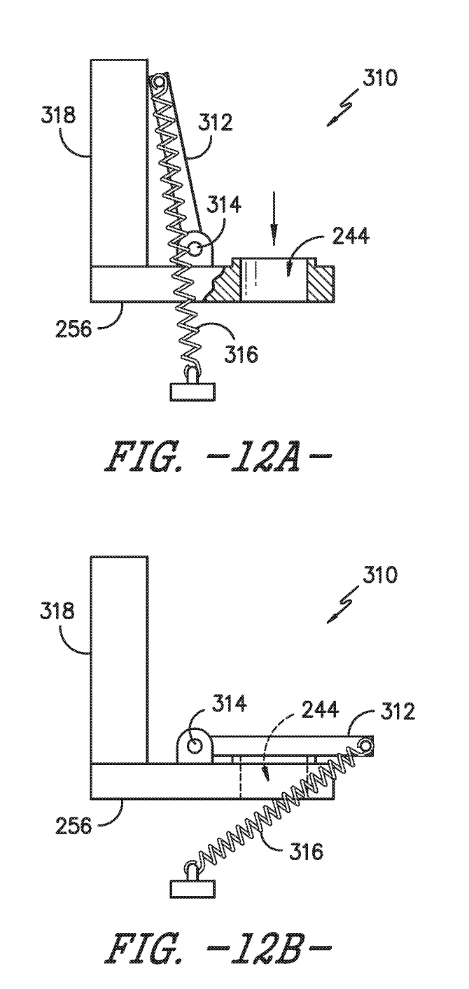

According to the illustrated embodiment, the flow controlling device that is operably coupled with valve gear 276 is a protrusion 300 extending along a radial direction from valve gear 276. As best illustrated in FIGS. 10 and 11, protrusion 300 is configured to block outlet 244 when the target flow capacity is reached. More specifically, FIGS. 10A and 10B illustrate valve gear 276 and outlet 244 before the target flow capacity is reached. Notably, outlet 244 is unobstructed by protrusion 300, such that water may flow freely from inlet 242, through chamber 258, and out outlet 244.

FIGS. 11A and 11B illustrate valve gear 276 and outlet 244 after the target flow capacity is reached. Notably, outlet 244 is obstructed by protrusion 300, such that water is prevented from flowing through inlet 242. In this manner, valve gear 276 is configured to rotate protrusion 300 to block outlet 244 when the target flow capacity is reached, thereby stopping the flow of water through filter assembly 200. The stoppage of water flow may notify the user that filter cartridge 202 needs to be replaced. After the user removes filter cartridge 202, protrusion 300 serves to keep water in filter cartridge 202. In addition, protrusion 300, which may be red to improve visibility, is visible to the user looking into the bottom of filter cartridge 202 at outlet 244, thereby providing a visual indicator that filter cartridge 202 has expired.

Performance indication device 240 may further include a mechanical stop 302 to prevent valve gear 276 from rotating past outlet 244. In this regard, mechanical stop 302 may be a ridge defined on outlet cap 256 adjacent outlet 244 that is configured to engage protrusion 300 and prevent its rotation when filter cartridge 202 has expired. According to the exemplary embodiment, gear reduction assembly 274 is configured to rotate valve gear 276 slightly less than one full revolution during the lifetime of filter cartridge 202. Thus, as paddlewheel 270 makes 1,802,885 revolutions, valve gear 276 rotates less than one full revolution, at which time filter cartridge 202 should be replaced.

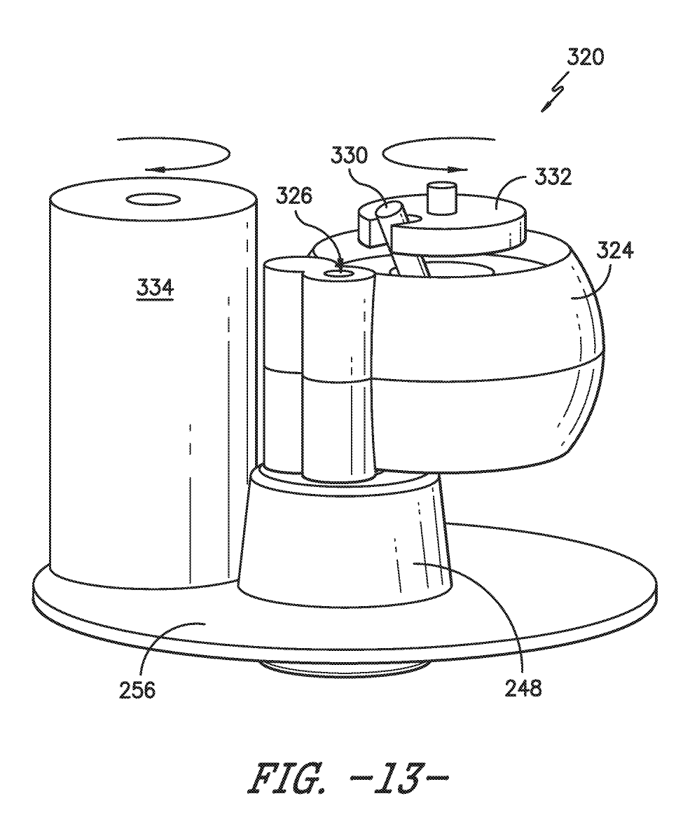

According to an alternative embodiment of the present subject matter, valve gear 276 may serve as an actuating means for an alternative valve closing mechanism. For example, in some applications, it may be desirable to shut off flow immediately when the target capacity is reached instead of slowly reducing the flow rate as protrusion 300 rotates to block outlet 244. In such cases, instead of blocking outlet 244, protrusion 300 may actuate a spring-loaded flap mechanism 310. More specifically, as illustrated in FIGS. 12A and 12B, a flap valve 312 may be pivotally attached to outlet cap 256 proximate outlet 244 by a hinge 314. A spring 316 may be connected to a distal end of flap valve 312 to bias flap valve 312 in the open position.

Flap valve 312 remains in an open position (FIG. 12A) throughout the lifetime of filter cartridge 202. In this regard, flap valve 312 may rest against a fixed wall 318 such that spring 316 urges flap valve 312 to remain in the open position. Thus, water may flow freely through outlet 244 throughout the life of filter cartridge 202. Notably, drive gear 264, gear reduction assembly 274, and valve gear 276 may operate in a similar manner as discussed above. However, as valve gear 276 rotates, instead of engaging outlet 244 to restrict fluid flow, protrusion 300 is configured to engage and rotate flap valve 312 toward the end of the lifetime of filter cartridge 202. After flap valve 312 is rotated past a certain point, the force exerted by spring 316 is configured to urge flap valve 312 instantaneously toward a closed position (FIG. 12B). In the closed position, flap valve 312 blocks outlet 244 to prevent fluid flow in a manner similar to protrusion 300 as explained above. However, contrary to the embodiment discussed above, the flow of fluid through outlet 244 is instantaneous instead of gradual, which may be desirable in certain applications.

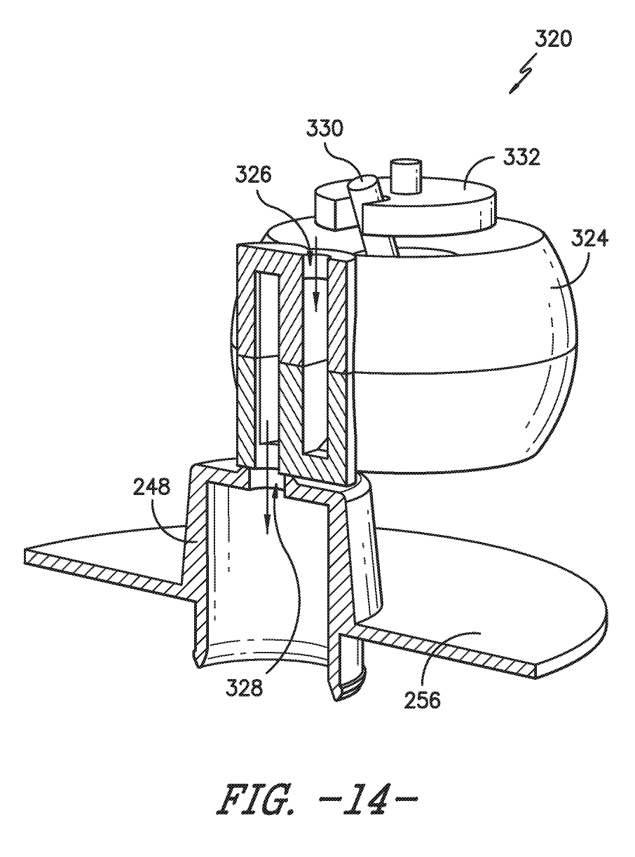

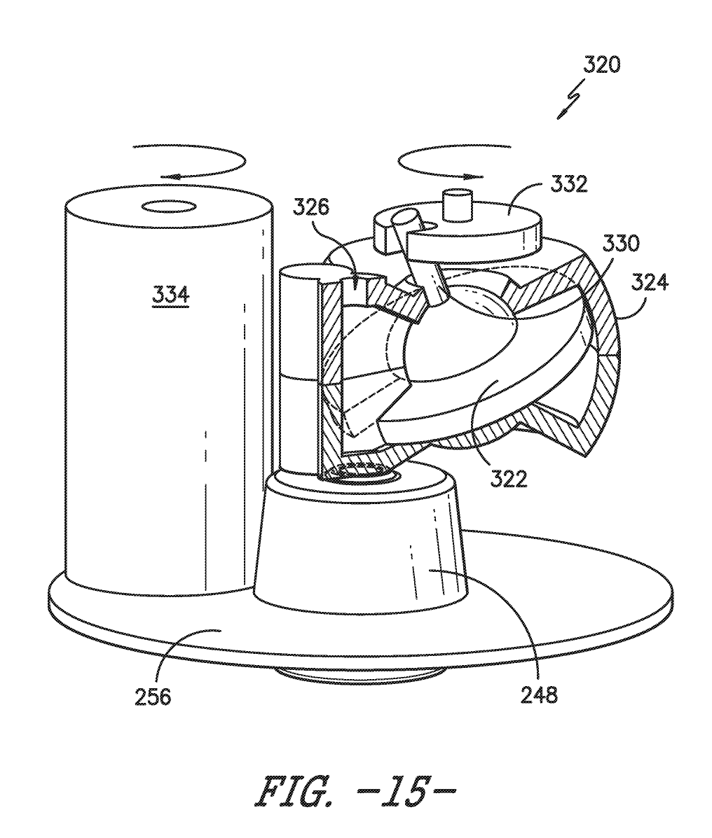

Referring now to FIGS. 13 through 15, a performance indication device 320 according to an alternative embodiment of the present subject matter will be described. Performance indication device 320 is similar to performance indication device 240 and may be used in filter cartridge 202, except that it uses an alternative flow metering device and flow control device. More specifically, performance indication device 320 uses a nutating disk 322 positioned within a housing 324 to measure the flow of water through filter element 226 and stop flow when the target capacity is reached.

Nutating disk 322 operates based on the displacement of water flowing through housing 324. More specifically, water flows from interior passage 228 through an inlet 326 and into housing 324. The water causes nutating disk 322 to nutate, i.e., rock and sway about an axis defined by a shaft 330. As the nutating disk 322 nutates, water is passes through an outlet 328 that corresponds with outlet 244. Shaft 330 is operably coupled with a drive gear 332, which operates in the same manner as drive gear 264 in performance indication device 240. Drive gear 332 is operably coupled with a gear reduction assembly 334 (connecting gear removed for clarity). A final gear (not shown) in gear reduction assembly 334 is configured to hit a mechanical stop (not shown) when the lifetime of filter cartridge 202 has expired. After the final gear is stopped, gear reduction assembly 332 prevents drive gear 332 from rotating and thus locks nutating disk 322 in place. Notably, when nutating disk 322 is prevented from nutating, the flow of water through housing 324 ceases.

Although various water metering devices and flow control devices are described above, one skilled in the art will appreciate that these are used only for the purpose of explaining aspects of the present subject matter. Other water metering devices and flow control devices may be used while remaining within the scope of the present subject matter. For example, water metering device may be any device that converts the energy of the water flowing through filter cartridge 202 into mechanical rotation which powers drive gear 264. The water metering device can be executed using a velocity approach, e.g., using a turbine or a paddlewheel, or a displacement approach, e.g., using a nutating disc, a rotary vane, a diaphragm, or an oscillating cylinder.

Although performance indication device 240 is described below as being positioned downstream of filter element 226, such that it measures the flow of filtered water, one skilled in the art will appreciate that this is only an exemplary embodiment and that other configurations of performance indication device 240 may be used. For example, performance indication device 240 may be configured for measuring the flow of unfiltered water prior to flowing through filter element 226. In addition, although performance indication device 240 is illustrated as being enclosed within filter cartridge 202, performance indication device 240 could instead by attached to an end of filter cartridge and may be used to join filter cartridge 202 to filter manifold 204. According to still another embodiment, performance indication device 240 might not be attached to filter cartridge 202 at all, but may instead be installed directly onto filter manifold 204. Other configurations are possible and within the scope of the present subject matter.

According the illustrated embodiment, inlet cap 254 has the same profile as the end cap used in conventional filters that do not include performance indications devices. Therefore, performance indication device 240 may be installed on these conventional filters and may operate in the same manner as described above to reduce or terminate flow when the lifetime of the filter has been expended. In such applications, the gear ratio of gear reduction assembly 274 may be adjusted as needed based on the type and size of filter media used. Alternatively, the initial angular position of valve gear 276 can be adjusted to achieve different flow capacities. Thus the same gear reduction assembly 274 can be adjusted for use with different filters having various capacities.

Notably, the claimed capacity of a water filter is a controlled parameter in filter design and is used during filter performance tests to confirm filtration performance claims. Filter systems equipped with an acceptable performance indication device (e.g., 240, 320) have more lenient regulatory testing standards. The standards set forth by regulatory agencies, such as ANSI, require a specific amount of flow reduction when a filter approaches its claimed capacity. The present subject matter provides for a compact and reliable mechanical performance indication device that is completely integrated into filter cartridge 202. When the filter capacity is reached the device will terminate or reduce water flow through the filter and provide a visual indication that the filter capacity has been reached. Performance indication devices 240, 320 thus provide an accurate indication to the user as to when filter capacity has been expended without the need for a complex control system or communication link or any modification of the appliance on which the filter is installed.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A performance indication device for a filter, the performance indication device comprising:
an inlet and an outlet in fluid communication with the filter;
a drive gear;
a water metering device configured for converting the energy of water flowing through the inlet into the rotational energy of the drive gear;
a gear reduction assembly operably coupling the drive gear to a valve gear, the gear reduction assembly defining a gear ratio such that the rotational speed of the valve gear is reduced relative to the rotational speed of the drive gear by the gear ratio; and
a flow controlling device that is operably coupled to the valve gear, the flow controlling device configured to reduce or terminate the flow of water through the performance indication device and the filter when a target flow capacity is reached.

2. The performance indication device of claim 1, wherein the flow controlling device is a protrusion extending along a radial direction from the valve gear, the protrusion configured to block the outlet when the target flow capacity is reached.

3. The performance indication device of claim 2, wherein the protrusion blocks the outlet after approximately one revolution of valve gear.

4. The performance indication device of claim 2, wherein the protrusion is visible from outside of the performance indication device when blocking the outlet to provide a visual indicator that the flow capacity has been reached.

5. The performance indication device of claim 1, wherein the flow controlling device is a spring-loaded flap valve that rotates to block the outlet after the valve gear has rotated approximately one revolution.

6. The performance indication device of claim 1, wherein the gear reduction assembly comprises more than four gears.

7. The performance indication device of claim 1, wherein the gear ratio is greater than 1,000,000 to 1.

8. The performance indication device of claim 1, wherein the water metering device is a turbine or a paddlewheel positioned adjacent the inlet such that the water metering device is driven by the flow of water through the inlet.

9. The performance indication device of claim 1, wherein the water metering device is a nutating disk, a rotary vane, a diaphragm, or an oscillating cylinder positioned adjacent the inlet such that the water metering device is driven by the flow of water through the inlet.

10. The performance indication device of claim 1, wherein the inlet is adjacent and in fluid communication with a filter outlet of the filter.

11. The performance indication device of claim 1, wherein the performance indication device is positioned within a housing of the filter.

12. A fluid filter assembly comprising:
a filter housing defining a filter chamber;
a filter inlet for supplying unfiltered fluid to the filter housing;
a filter medium positioned within the filter chamber, the filter medium operable to remove contaminants from water flowing through the filter medium;
a filter outlet for transferring filtered water from the filter chamber; and
a performance indication device positioned adjacent the filter chamber within the filter housing, the performance indication device comprising:
an inlet and an outlet in fluid communication with the filter chamber;
a drive gear;
a water metering device configured for converting the energy of water flowing through the inlet into the rotational energy of the drive gear;
a gear reduction assembly operably coupling the drive gear to a valve gear, the gear reduction assembly defining a gear ratio such that the rotational speed of the valve gear is reduced relative to the rotational speed of the drive gear by the gear ratio; and
a flow controlling device that is operably coupled to the valve gear, the flow controlling device configured to reduce or terminate the flow of water through the inlet when a target flow capacity is reached.

13. The fluid filter assembly of claim 12, wherein the flow controlling device is a protrusion extending along a radial direction from the valve gear, the protrusion configured to block the outlet when the target flow capacity is reached.

14. The fluid filter assembly of claim 13, wherein the protrusion blocks the outlet after approximately one revolution of valve gear.

15. The fluid filter assembly of claim 13, wherein the protrusion is visible from outside of the performance indication device when blocking the outlet to provide a visual indicator that the flow capacity has been reached.

16. The fluid filter assembly of claim 12, wherein the flow controlling device is a spring-loaded flap valve that rotates to block the outlet after the valve gear has rotated approximately one revolution.

17. The fluid filter assembly of claim 12, wherein the gear reduction assembly comprises more than four gears and the gear ratio is greater than 1,000,000 to 1.

18. The fluid filter assembly of claim 12, wherein the water metering device is a turbine or a paddlewheel positioned adjacent the inlet such that the water metering device is driven by the flow of water through the inlet.

19. The fluid filter assembly of claim 12, wherein the water metering device is a nutating disk, a rotary vane, a diaphragm, or an oscillating cylinder.

20. The fluid filter assembly of claim 12, wherein the inlet is adjacent and in fluid communication with the filter outlet.
